(19) United States
(12) Patent Application Publication
(10) Pub. No.: US 2007/0278955 A1
(43) Pub. Date: Dec. 6, 2007

(54) Manufacturing method of plasma display panel and plasma display panel

(75) Inventors: Yoshihiko Kusuma, Chuo-shi (JP); Yuji Ito, Chuo-shi (JP); Youichi Ikarashi, Chuo-shi (JP); Keiji Nunomura, Chuo-shi (JP); Toshihiko Kogure, Chuo-shi (JP); Osamu Oida, Chuo-shi (JP); Takahiro Kobayashi, Chuo-shi (JP)

Correspondence Address: KRATZ, QUINTOS & HANSON, LLP, 1420 K Street, N.W., Suite 400, WASHINGTON, DC, 20005, US

(73) Assignees: PIONEER CORPORATION, Tokyo (JP); Advanced PDP Development Center Corporation, Tokyo (JP)

(21) Appl. No.: 11/730,797

(22) Filed: Apr. 4, 2007

(30) Foreign Application Priority Data
Apr. 7, 2006 (JP) 2006-106872

(51) Int. Cl. H01J 9/38

(52) U.S. Cl. 313/582; 445/9

(57) ABSTRACT

A manufacturing method of a PDP includes: a first material filling step for filling recessed portions (41) of a molding die (4) with a first dielectric paste (23A) that forms partitions; a second material application step for applying a second dielectric paste (22A) that forms an address electrode protective layer on a rear substrate (2); a transfer step for pressing the molding die (4) against the second dielectric paste (22A) and then peeling the molding die (4) off from the rear substrate (2); and a firing step. Since the molding die (4) is pressed against the second dielectric paste (22A) that has a fluidity in the transfer step, the first dielectric paste (23A) and the second dielectric paste (22A) can be adhered to each other securely. Accordingly, the partitions having a desired shape can be formed securely and inter-partition portions of the address electrode protective layer can be uniformly formed with a uniform thickness.

### BACKGROUND OF THE INVENTION

1. Field of the Invention

The present invention relates to a manufacturing method of a plasma display panel and the plasma display panel.

2. Description of Related Art

There has been conventionally known a plasma display panel (PDP) including a pair of substrates that are arranged facing each other with a discharge space therebetween. The PDP includes a dielectric layer that is provided so as to cover a surface on the discharge space side of one substrate of the pair of substrates; and partitions that are provided on the dielectric layer, the partitions projecting toward the discharge space so as to zone the discharge space into a plurality of unit emitting regions.

Although the partitions have been typically formed by sandblasting, there have been recently proposed transfer methods for forming the partitions because the transfer methods are capable of forming the partitions in a desired shape more properly as compared to the sandblasting (see, for instance, Document 1: JP-A-8-273537, page 4 and FIG. 1, Document 2: JP-A-2000-299067, page 4 and FIG. 2, Document 3: JP-A-8-273538, page 4 and FIG. 1, Document 4: JP-A-2000-243266 page 5 and FIG. 1, and Document 5: JP-A-2001-49465, page 5 and FIG. 1).

A method disclosed in Document 1 uses a mold sheet having sheet recess portions having a shape inverted to that of cell barriers (partitions). A glass paste is fed to the sheet recess portions of the mold sheet by, for instance, blade coating using a blade to fill the sheet recess portions with the glass paste. While the filled glass paste is still wet, the sheet recess portion side of the mold sheet is brought into contact with a glass substrate side to adhere the glass paste filled in the sheet recess portions to the glass substrate. Then, the mold sheet is peeled off from the glass substrate so that the grass paste is transferred onto the glass substrate. Through the process described above, the cell barriers are formed on the glass substrate.

A method disclosed in Document 2 uses a partition-forming recessed plate having a shape inverted to partitions. Grooves of the partition-forming recessed plate are filled with a partition-forming material by doctor blade coating or the like, and then the partition-forming material is further fed on the partition-forming recessed plate to form a layer having a uniform thickness. Through the process, the partitions and an electrode protective layer are transferred at a time onto the substrate.

A method disclosed in Document 3 uses a mold sheet having sheet recess portions having a shape inverted to that of cell barriers (partitions). A glass paste is applied uniformly on a surface of a glass substrate to form a layer having a predetermined thickness, and then a mold sheet is pressed against the glass substrate after the application of the glass substrate. Then, the mold sheet is peeled off to obtain the glass paste molded in a cell barrier shape, and the molded glass paste is fired.

A method disclosed in Document 4 includes filling recessed portions of a transfer plate with a barrier-forming material, orienting the barrier-material filled side of the transfer plate toward a glass substrate side, forming an elastic layer between the transfer plate and the glass substrate, and pressing the transfer plate against the glass substrate. Thereafter, the transfer plate is separated from the grass substrate to transfer the barrier-forming material from the transfer plate onto the glass substrate with the elastic layer therebetween, thereby forming a thick film pattern (partitions) on the glass substrate.

Here, the transfer plate is pressed against the glass substrate in a state where the elastic layer is fed in a sheet-shape and laminated on the glass substrate using a pressing roller or a material that forms the elastic layer is applied on the glass substrate using a squeegee and then dried.

A method disclosed in Document 5 is similar to the method disclosed in Document 4 except that the method employs a plastic layer instead of the elastic layer. Similarly to the method of Document 4, the transfer plate is pressed against the glass substrate in a state where the plastic layer is fed in a sheet-shape and laminated on the glass substrate using a pressing roller or a material that forms the plastic layer is applied on the glass substrate using a squeegee and then dried.

Meanwhile, in the method disclosed in Document 1, the glass paste on a surface of the mold sheet 100 is scraped by the blade to feed the glass paste only in the sheet recess portions 101, which causes the glass paste 102 inside the sheet recess portions 101 sinks toward the inner side of the sheet recess portions 101 due to the self-weight of the glass paste as shown in FIG. 1A. Accordingly, when the glass substrate 103 is brought into contact with the mold sheet 100, clearances 104 are formed on opening end sides of the sheet recess portions 101 as shown in FIG. 1B. When the mold sheet 100 is peeled off from the glass substrate 103, the glass paste 102 does not adhere completely to the glass substrate 103 due to the clearances 104 as shown in FIG. 1C, which might impede a portion of the glass paste 102 from being transferred onto the glass substrate 103. A PDP manufactured using such a substrate cannot provide a good display performance, so that the PDP will be treated as a defective product. Therefore, a yield rate is possibly lowered.

In the method disclosed in Document 2, since the grooves of the barrier-forming plate are filled with the barrier-forming material by the doctor blade coating, similarly to the method disclosed in Document 1, clearances similar to the clearances 104 shown in FIGS. 1A to 1C might be formed on opening end sides of the grooves. In addition, it is quite difficult to form a material layer uniformly with a desired thickness on the barrier-forming recessed plate having the grooves. Specifically, it is highly probable that the material layer is waved along the grooves after the scraping using the blade and the waving profile causes variation in thickness of the material, which results in variation in the thickness of the layer. Especially, a certain lead time is required between the forming step of the material layer on the recessed plate and the transfer step to the substrate, and the variation in thickness of the material gradually increases as the lead time gets longer, which causes the thickness of the entire layer becomes nonuniform. It is quite difficult to form a material layer uniformly with a desired thickness on the barrier-forming plate having the grooves in terms of manufacturing process. As a result, the yield rate is possibly lowered.

Since the method disclosed in Document 3 employs a method in which the mold sheet is pressed against the glass paste layer applied on the glass substrate instead of the method in which the glass paste is filled in the sheet recess portions and then transferred onto the glass substrate, it is difficult to control a pressure in pressing the mold sheet against the glass paste layer. Accordingly, a variation is likely generated in the pressure in pressing, and when the variation of the pressure is generated, it might become difficult to form the partitions in a desired shape. As a result, the yield rate is possibly lowered.

In the methods disclosed in Documents 4 and 5, the elastic layer or the plastic layer is provided between the transfer plate and the glass substrate in pressing the transfer plate against the glass substrate in order to enhance transfer performance. However, since the elastic layer or the plastic layer is formed by laminating a sheet-shaped one on the glass substrate or applying one on the glass substrate using the squeegee and then drying, the elastic or plastic layer is in a solidified state when the transfer plate is pressed against the glass substrate. Accordingly, in these methods, when clearances like the clearances 104 shown in FIGS. 1A to 1C are formed on opening end sides of recessed portions as in the method disclosed in Document 1, the elastic layer or the plastic layer is not sufficiently deformed by the pressing, which might impede the barrier-forming material from being securely transferred onto the substrate.

### SUMMARY OF THE INVENTION

An object of the present invention is to provide a manufacturing method of a plasma display panel that can properly manufacture the plasma display panel and realize a good display performance and the plasma display panel.

According to an aspect of the present invention, a manufacturing method of a plasma display that includes a pair of substrates facing each other with a discharge space therebetween, a dielectric layer that is provided so as to cover a surface of one substrate of the pair of substrates, the surface being on a discharge space side, partitions provided on the dielectric layer, the partitions projecting toward the discharge space so as to zone the discharge space into a plurality of unit emitting regions includes: a first material filling step for filling recessed portions of a molding die with a first material that forms the partitions, the recessed portions each having a shape inverted to a desired shape of the partitions; a second material application step for applying a second material in a paste form that forms the dielectric layer on the surface on the discharge space side of the one substrate, the second material applied to have a predetermined thickness; a transfer step for pressing the molding die with its recessed portions filled with the first material against the second material in the paste form applied on the one substrate and peeling the molding die from the one substrate to transfer the first material onto the second material; and a firing step for firing the second material applied on the one substrate and the first material transferred onto the second material to form the dielectric layer and the partitions on the one substrate.

According to another aspect of the present invention, the plasma display includes a pair of substrates facing each other with a discharge space therebetween, a dielectric layer that is provided so as to cover a surface of one substrate of the pair of substrates, the surface being on a discharge space side, partitions provided on the dielectric layer, the partitions projecting toward the discharge space so as to zone the discharge space into a plurality of unit emitting regions, in which the dielectric layer is so provided that joint portions jointing with the partitions project toward the partitions while portions that are not provided with the partitions in the surface on the discharge space side are formed to be flat.

According to still another aspect of the present invention, a plasma display includes a pair of substrates facing each other with a discharge space therebetween, a dielectric layer that is provided so as to cover a surface of one substrate of the pair of substrates, the surface being on a discharge space side, partitions provided on the dielectric layer, the partitions projecting toward the discharge space so as to zone the discharge space into a plurality of unit emitting regions, in which the partitions are so provided that joint portions jointing with the dielectric layer project toward the dielectric layer, and portions that are not provided with the partitions in the surface on the discharge space side of the dielectric layer are formed to be flat.

### BRIEF DESCRIPTION OF THE DRAWINGS

FIG. 1A is a cross section for schematically showing formation steps of an address electrode protective layer and partitions according to a manufacturing method of a conventional PDP, the cross section showing a mold sheet with its sheet recessed portions filled with a glass paste;

FIG. 1B is a cross section for schematically showing the formation steps of the address electrode protective layer and the partitions according to the manufacturing method of the conventional PDP, the cross section showing how the mold sheet is pressed against the glass substrate;

FIG. 1C is a cross section for schematically showing the formation steps of the address electrode protective layer and the partitions according to the manufacturing method of the conventional PDP, the cross section showing how the mold sheet is peeled off from the glass substrate;

FIG. 2 is an exploded perspective view showing an internal structure of a plasma display panel according to a first embodiment of the present invention;

FIG. 3 is a front view schematically showing the plasma display panel according to the first embodiment;

FIG. 4A is a cross section for schematically showing formation steps of an address electrode protective layer and partitions according to the first embodiment, the cross section showing a molding die in a first material filling step;

FIG. 4B is a cross section for schematically showing the formation steps of the address electrode protective layer and the partitions according to the first embodiment, the cross section showing a rear substrate in a second material application step;

FIG. 4C is a cross section for schematically showing the formation steps of the address electrode protective layer and the partitions according to the first embodiment, the cross section showing how the molding die is pressed against the rear substrate in a transfer step;

FIG. 4D is a cross section for schematically showing the formation steps of the address electrode protective layer and the partitions according to the first embodiment, the cross section showing how the molding die is peeled off from the rear substrate in the transfer step;

FIG. 5 is a cross section of the rear substrate after a firing step according to the first embodiment;

FIG. 6A is a cross section for schematically showing formation steps of an address electrode protective layer and partitions according to a second embodiment of the present invention, the cross section showing a molding die in a first material filling step;

FIG. 6B is a cross section for schematically showing the formation steps of the address electrode protective layer and the partitions according to the second embodiment, the cross section showing a rear substrate in a second material application step;

FIG. 6C is a cross section for schematically showing the formation steps of the address electrode protective layer and the partitions according to the second embodiment, the cross section showing how the molding die is pressed against the rear substrate in a transfer step;

FIG. 6D is a cross section for schematically showing the formation steps of the address electrode protective layer and the partitions according to the second embodiment, the cross section showing how the molding die is peeled off from the rear substrate in the transfer step;

FIG. 7 is a cross section of the rear substrate after a firing step according to the second embodiment; and

FIG. 8 is a cross section of a front substrate after a firing step according to a third embodiment of the present invention.

### DETAILED DESCRIPTION OF PREFERRED EMBODIMENT(S)

### (1) First Embodiment

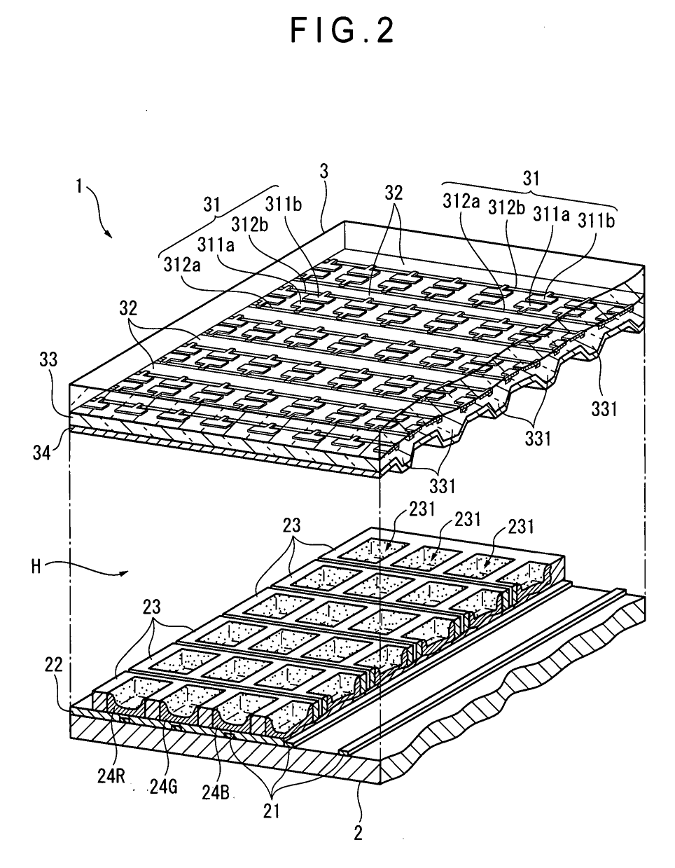

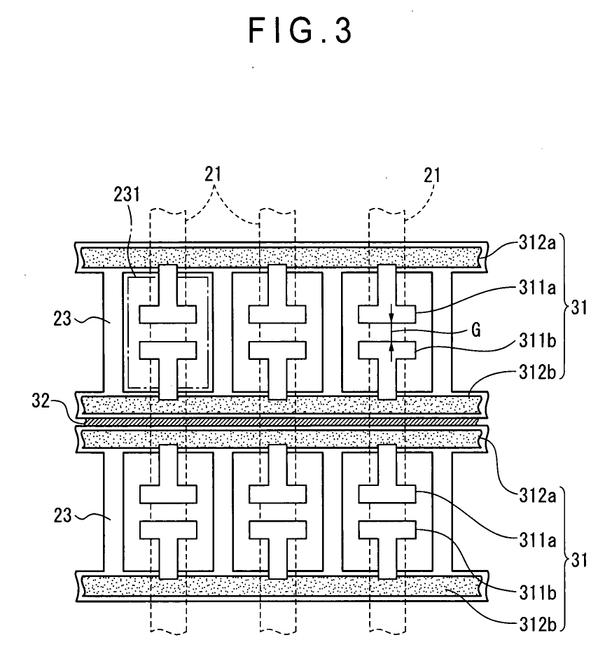

A first embodiment of the present invention will be described below with reference to the attached drawings. FIG. 2 is an exploded perspective view showing an internal structure of a plasma display panel according to the first embodiment of the present invention. FIG. 3 is a front view schematically showing the plasma display panel.

### (1-1) Arrangement of Plasma Display Panel

In the first embodiment, as shown in FIG. 2, the reference numeral 1 denotes a plasma display panel (PDP). The PDP 1 is formed in, for instance, a substantially planar rectangular shape and is a device that displays an image utilizing light emission generated by plasma discharge. The PDP 1 includes a pair of substrates (a rear substrate 2 and a front substrate 3) that are arranged facing each other with a discharge space H therebetween, the discharge space H defining an image display area.

The rear substrate 2 and the front substrate 3 are sealed with a frit seal (not shown) provided on each outer circumference of the substrates. The inside of the sealed space is maintained at a reduced pressure of about 6.7×104 Pa (500 Torr), and the space is filled with inactive gas such as He—Xe (helium-xenon) system gas and Ne—Xe (neon-xenon) system gas.

The rear substrate 2 is typically formed of a glass material in a planar rectangular shape. Provided on an inner surface of the rear substrate 2 are a plurality of linear address electrodes 21, an address electrode protective layer 22 covering the address electrodes 21, partitions 23 integrally formed on the address electrode protective layer 22 and fluorescent layers (24R, 24G, 24B) that are formed in discharge cells 231 defined by the partitions 23.

Specifically, the address electrodes 21 are each formed of, for instance, Al (aluminum). The plurality of address electrodes 21 are linearly formed substantially along a direction (column direction) orthogonal to a longitudinal direction (row direction) of the rear substrate 2, the address electrodes 21 arranged at a predetermined interval in the row direction. An end of each address electrode 21 is provided with an address electrode leading portion (not shown), through which a voltage pulse from a column electrode driver (not shown) is applied to the address electrode 21.

The address electrode protective layer 22 is formed of a dielectric paste or the like and provided substantially on the entire surface (except the electrode leading portion) of the inner surface of the rear substrate 2. The address electrode protective layer 22 prevents the address electrode 21 from being damaged by the discharge during drive of the panel while serving as a dielectric layer that accumulates electric charges required for the drive. An outer circumference of the address electrode protective layer 22 is provided with the above-mentioned frit seal.

The partition 23 is formed of a dielectric paste or the like in a substantially ladder-like shape. A plurality of the partitions 23 is aligned in parallel on the address electrode protective layer 22, and a linear gap substantially orthogonal to the address electrode 21 is interposed between each pair of the partitions 23. The partitions 23 zone the discharge space H into a plurality of rectangular discharge cells (unit emitting regions) 231. The partitions 23 each have a predetermined height from its base end to top, the height defining a space dimension of a gap between the rear substrate 2 and the front substrate 3.

The fluorescent layers (24R, 24G, 24B) are formed by filling the discharge cells 231 sequentially with fluorescent pastes of three primary colors of red (R), green (G) and blue (B) and firing the fluorescent pastes. The fluorescent layers (24R, 24G, 24B) are excited by ultraviolet rays from discharge emission in each discharge cell 231 and emit visible light of the three primary colors red (R), green (G) and blue (B).

The front substrate 3 serves as a display surface of the PDP 1, the front substrate 3 formed of the same material and in the same shape as the rear substrate 2. As shown in FIG. 3, provided on an inner surface of the front substrate are a plurality of display electrode pairs 31 that are arranged at a predetermined interval in a direction substantially orthogonal to the address electrodes 21, a plurality of black stripes 32 each provided between the display electrode pairs 31, a dielectric layer 33 that covers the display electrode pairs 31 and the black stripes 32, a protective layer 34 that covers the dielectric layer 33 and the like.

Specifically, the display electrode pair 31 includes: plural pairs of transparent electrodes 311a, 311b that face with each other via a discharge gap G therebetween (see FIG. 3); and a pair of linear bus electrodes 312a, 312b laminated on respective ends of the transparent electrodes 311a, 311b.

The transparent electrodes 311a, 311b are each a transparent conductive film that is formed of ITO (Indium Tin Oxide) or the like and substantially has a T-shape, the transparent electrodes 311a, 311b provided as a pair for each predetermined discharge cell 231.

The bus electrodes 312a, 312b, are each linearly formed of Ag (silver) or the like, the bus electrodes 312a, 312b laminated on the respective ends of the pair of transparent electrodes 311a, 311b, the ends being on sides opposite to the discharge gap G. An end of each of the bus electrodes 312a, 312b is provided with a buss electrode leading portion (not shown), through which a voltage pulse from a row electrode driver (not shown) is applied to each of the transparent electrodes 311a, 311b.

The black stripe 32 is linearly formed of a black inorganic pigment or the like. The black stripe 32 absorbs visible light irradiated from the outside of the front substrate 3.

The dielectric layer 33 is formed of a dielectric paste or the like, the dielectric layer 33 arranged so as to face the address electrode protective layer 22 of the rear substrate 2. The dielectric layer 33 prevents the display electrode pair 31 from being damaged by the discharge during drive of the panel and accumulates electric charges required for the drive.

Provided on portions facing the bus electrodes 312a, 312b on the dielectric layer 33 is a thickened dielectric layer 331 that projects toward the discharge space H. The thickened dielectric layer 331 prevents mis-discharge between the discharge cells 231 that are adjacent to each other in the column direction.

The protective layer 34 is a transparent layer that is formed from MgO (magnesium oxide) by vapor deposition, sputtering or the like, the protective layer 34 covering the entire inner surface of the dielectric layer 33. The protective layer 34 prevents the dielectric layer 33 from being sputtered due to the discharge while serving as a discharge layer of a secondary electron for generating the discharge at a low voltage.

### (1-2) Manufacturing Method of PDP 1

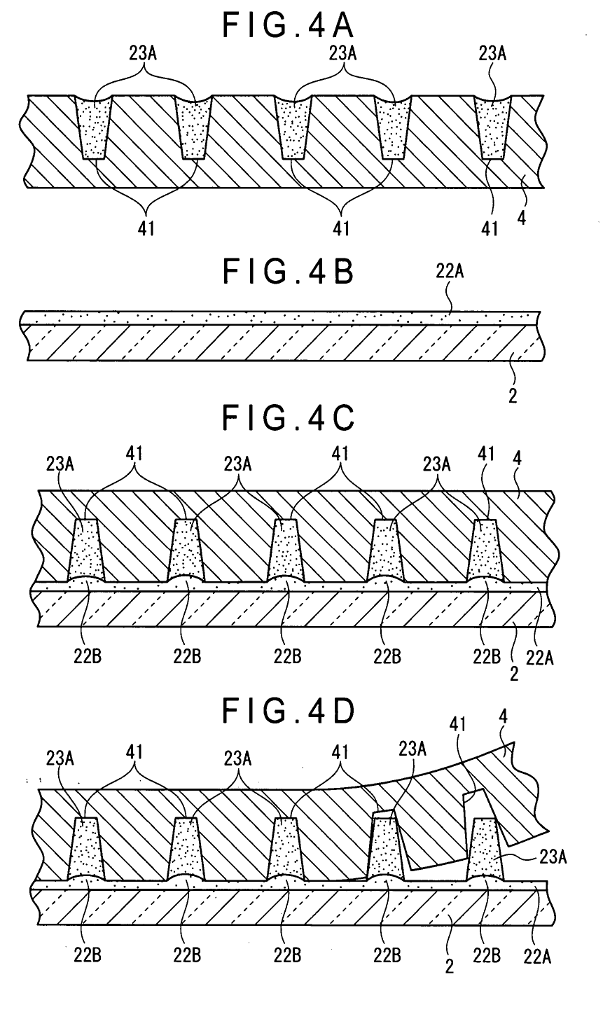

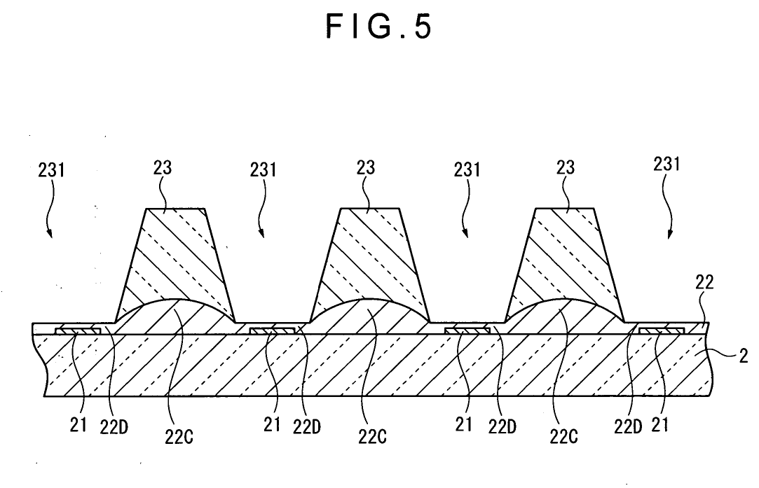

Now, as a manufacturing method of the PDP 1 having the arrangement described above, forming steps of the address electrode protective layer 22 and the partitions 23 will be described with reference to the drawings. FIGS. 4A to 4D each schematically show forming steps of the address electrode protective layer and the partitions, where FIG. 4A is a cross section of a molding die in a first material filling step; FIG. 4B is a cross section of the rear substrate in a second material application step; FIG. 4C is a cross section showing a state where the molding die is pressed against the rear substrate in a transfer step; and FIG. 4D is a cross section showing a state where the molding die is peeled off from the rear substrate in the transfer step. FIG. 5 is a cross section of the rear substrate after a firing step.

As a preceding process for forming the address electrode protective layer 22 and the partitions 23, a metal film is deposited on the entire inner surface of the rear substrate 2 and a pattern of the address electrodes 21 is formed by photo lithography. Thereafter, the forming steps of the address electrode protective layer 22 and the partitions 23 are performed. Specifically, a molding die preparation step, the first material filling step, the second material application step, the transfer step and the firing step are performed.

In the molding die preparation step, a molding die 4 that has recessed portions 41 having a shape inverted to a desired shape of the partitions 23 as shown in FIGS. 4A, 4C and 4D is prepared. Herein, the wording “having a shape inverted to a desired shape of the partitions 23” refers not only to a shape that is simply inverted to the shape of the partitions 23 but also to a shape that is inverted to a shape slightly different from the shape of the partitions 23 by taking into account a volume change of a glass paste after the firing step.

As a concrete example of the molding die preparation step, for example, a rib substrate that has partitions substantially having the same shape (e.g., height: 160 μm, partition width: 60 μm) as the partitions 23 is formed by sand blasting. After spraying a silicone resin on a surface of the rib substrate, a hot-melt adhesive is applied until grooves are sufficiently covered and hidden therewith. A PET (PolyEthylene Terephthalate) film having a thickness of 200 μm is adhered on the hot-melt adhesive layer and air-cured. Then, the film and the like are peeled off from the rib substrate to obtain the molding die 4 shown in FIGS. 4A, 4C and 4D.

In the first material filling step, after spraying a silicone resin on a surface provided with the recessed portions 41 of the molding die 4, a first dielectric paste 23A that forms the partitions 23 is applied on this surface of the molding die 4. The first dielectric paste 23A used herein is exemplified by a mixture of 15 wt % of a resin that is photo-cured by light of a certain wavelength and 85 wt % of a glass frit containing PbO (glass component).

Next, a rubber flat squeegee (e.g., hardness #60) is kept in contact with and slid on the surface having the recessed portions 41 of the molding die 4. With the operation, the first dielectric paste 23A is fed only in the recessed portions 41 while the first dielectric paste 23A applied on the surface is removed, whereby a state shown in FIG. 4A is obtained.

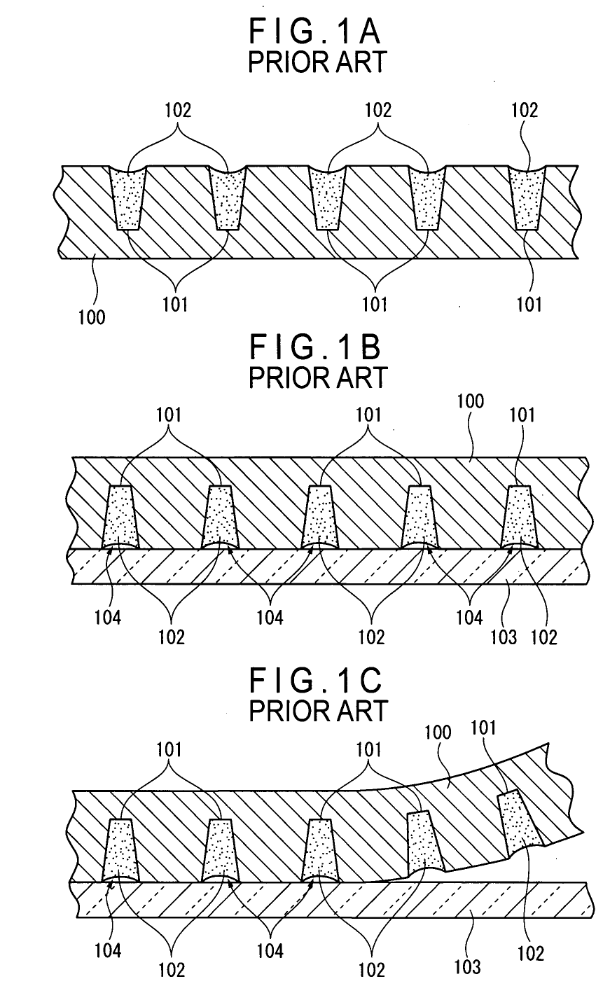

In this state, the first dielectric paste 23A filled in the recessed portion 41 is sunk toward the inner side of the recessed portions 41 due to its own weight and an upper portion (in the drawing) of the first dielectric paste 23A is recessed in a manner similar to the conventional arrangement (see FIGS. 1A to 1C).

In the second material application step, as shown in FIG. 4B, a second dielectric paste 22A that forms the address electrode protective layer 22 is applied on the rear substrate 2 on which the address electrodes 21 are formed, the second dielectric paste 22A applied to have a predetermined thickness (e.g., 30 μm) by known application methods such as screen printing or die coating. At this time, the viscosity of the second dielectric paste 22A is adjusted such that the viscosity will be in the range from 1 to 200 Pa·s (from 1000 to 200000 cp) in a later-described transfer step. For example, the viscosity of the second dielectric paste 22A is so adjusted that, even when a dry step is provided after applying the second dielectric paste 22A on the rear substrate 2, the second dielectric paste 22A is maintained to be a paste state having the viscosity of 1 to 200 Pa·s (from 1000 to 200000 cp) in the following transfer step.

As described above, since the filling of the first dielectric paste 23A in the recessed portions 41 of the molding die 4 and the application of the second dielectric paste 22A on the rear substrate 2 are performed as different steps, different materials can be employed for the first dielectric paste 23A and the second dielectric paste 22A.

Accordingly, optimum materials can be selected by taking into account performances required for each of the address electrode protective layer 22 and the partition 23. Specifically, for instance, a material capable of stably maintaining the shape of the partition 23 can be selected for the partition 23, while a material that is less expensive can be selected for the address electrode protective layer 22 having no such limitation. In addition, in view of requirements such as reflectivity and dielectric constant, materials suitable for each of the partition 23 and the address electrode protective layer 22 can be selected. In this regard, in the arrangement disclosed in Document 2, since the partition and the address electrode protective layer are formed from a common material, a material suitable for the both components needs to be selected. In contrast, there is no such limitation in the first embodiment, so that materials optimum for each of the components can be individually selected. Accordingly, a PDP having a higher luminous efficiency and a lower power consumption can be manufactured.

In the transfer step, the molding die 4 shown in FIG. 4A is opposed to the rear substrate 2 shown in FIG. 4B on which the second dielectric paste 22A is applied, and the molding die 4 and the rear substrate 2 are attached to each other. Then, for instance, a roller having a diameter of 50 mm is moved on a back surface of the molding die 4 to apply a small pressure thereon. With the operation, the first dielectric paste 23A and the second dielectric paste 22A are completely adhered to each other as shown in FIG. 4C. Specifically, the second dielectric paste 22A that is in a paste state and fluid enters into clearances formed between the upper portions of the recesses of the first dielectric paste 23A (upper portion in FIG. 4A) and the second dielectric paste 22A, so that the clearances are filled with the second dielectric paste 22A. As a result, joint portions 22B projecting toward the first dielectric paste 23A are formed on the second dielectric paste 22A, where the first dielectric paste 23A is securely adhered to the second dielectric paste 22A. Portions other than the joint portions 22B of the second dielectric paste 22A are formed to be flat because a flat surface that is not provided with the recessed portions 41 of the molding die 4 abuts on the portions.

Note that the viscosity of the second dielectric paste 22A in the transfer step is preferably adjusted to be in the range from 1 to 200 Pa·s, more preferably in the range from 5 to 20 Pa·s.

When the viscosity of the second dielectric paste 22A is below the 1 Pa·s, it has been verified from an experiment that a slump occurs during the transfer step due to its high fluidity and the address electrode protective layer 22 cannot be maintained in a desired thickness and shape.

On the other hand, when the viscosity of the second dielectric paste 22A is above 200 Pa·s, it has been verified from an experiment that the second dielectric paste 22A cannot be filled in the entire clearances formed on the upper portions of the first dielectric paste 23A due to its poor fluidity in the transfer step, which causes small clearances to be left.

Accordingly, by adjusting the viscosity of the second dielectric paste 22A in the transfer step to be in the range from 1 to 200 Pa·s, the clearances can be completely filled while maintaining the desired thickness and shape of the address electrode protective layer 22.

Note that in the arrangements disclosed in Documents 4 and 5, the elastic layer and the plastic layer are solidified in attaching the transfer plate and the glass substrate and do not have a proper fluidity unlike the first embodiment, the clearances of the first embodiment might not be filled completely with those layers.

Thereafter, in a state where the molding die 4 and the rear substrate 2 are attached to each other, light of a certain wavelength is irradiated to the first dielectric paste 23A from the rear substrate 2 side. In a case where the hot-melt adhesive, the PET film and the silicone resin that form the molding die 4 are light-transmissive, light having a certain wavelength is irradiated to the first dielectric paste 23A from the back surface side of the molding die 4. With the operation, the first dielectric paste 23A is cured and adhered onto the second dielectric paste 22A.

After curing the first dielectric paste 23A, the molding die 4 is peeling off from the rear substrate 2 as shown in FIG. 4D. With the operation, the first dielectric paste 23A having a shape corresponding to the partitions 23 is formed on the second dielectric paste 22A of the rear substrate 2.

In the firing step, the first dielectric paste 23A and the second dielectric paste 22A formed on the rear substrate 2 are fired. With the operation, the resin components and paste solvents contained in the first dielectric paste 23A and the second dielectric paste 22A are volatilized and the glass components are melted. Then, by cooling the rear substrate 2 down to the ambient temperature, the glass components of the first dielectric paste 23A and the second dielectric paste 22A are solidified, whereby the address electrode protective layer 22 and the partitions 23 are formed on the rear substrate 2 as shown in FIG. 5.

After forming the address electrode protective layer 22 and the partitions 23, the fluorescent pastes of the three primary colors of red (R), green (G) and blue (B) are applied in the discharge cells 231 by screen printing or the like, which are fired to form the fluorescent layers (24R, 24G, 24B). With the operation, the rear substrate 2 of the PDP 1 is completed.

In the rear substrate 2 obtained by the above-described steps, the address electrode protective layer 22 are so formed that joint portions 22C with the partitions 23 project toward the partitions 23, while inter-partition portions 22D that are not provided with the partitions 23 are formed to be flat as shown in FIG. 5. In other words, by performing the firing step described above, the joint portions 22B (see FIG. 4C) of the second dielectric paste 22A form the joint portion 22C of the address electrode protective layer 22, while the portions other than the joint portions 22B of the second dielectric paste 22A form the inter-partition portions 22D of the address electrode protective layer 22.

Meanwhile, a variation in thickness of the inter-partition portion 22D in the discharge cell 231 is a major factor that affects drive (i.e., changes a margin of the drive voltage) of the PDP, where the variation includes a variation in thicknesses between the inter-partition portion 22D of one discharge cell 231 and that of another discharge cell 231. In short, generation of the variation in the thickness of the inter-partition portion 22D might cause mis-discharge.

In this regard, with the arrangement disclosed in Document 2, since the material layer is applied on the partition-forming recessed plate to form the address electrode protective layer 22 on the rear substrate 2, it is difficult to form the material layer to have a uniform thickness on the partition-forming recessed plate and thus difficult to form the inter-partition portions 22D of the discharge cells 231 to be flat. Accordingly, there is possibility that the mis-discharge occurs.

In contrast, in the first embodiment, since the thickness of the address electrode protective layer 22 is adjusted by applying the second dielectric paste 22A on the flat rear substrate 2, the thickness is stable. In addition, the portions other than the joint portions 22B of the second dielectric paste 22A are formed to be flat since the flat surface that is not provided with the recessed portions 41 of the molding die 4 abuts on the portions. Accordingly, as compared to the arrangement disclosed in Document 2, the thickness of the inter-partition portion 22D can be maintained uniformly, a possibility of occurrence of the mis-discharge can be reduced.

### (1-3) Advantages of First Embodiment

According to the first embodiment above, the following advantages can be attained.

(1-3-1) The manufacturing method of plasma display panel of the first embodiment includes the first material filling step, the second material application step, the transfer step and the firing step. In the first material filling step, the recessed portions 41 having the shape inverted to the desired shape of the partitions 23 of the molding die 4 are filled with the first dielectric paste 23A that forms the partitions 23. In the second material application step, the second dielectric paste 22A that forms the address electrode protective layer 22 is applied to have a predetermined thickness on the surface on the discharge space H side of the rear substrate 2. In the transfer step, the molding die 4 with its recessed portions 41 being filled with the first dielectric paste 23A is pressed against the second dielectric paste 22A and then the molding die 4 is peeled off from the rear substrate 2, whereby the first dielectric paste 23A is transferred onto the second dielectric paste 22A. In the firing step, the second dielectric paste 22A and the first dielectric paste 23A are fired to form the address electrode protective layer 22 and the partitions 23 on the rear substrate 2.

As described above, since the molding die 4 is pressed against the second dielectric paste 22A in the transfer step, even when the upper portions of the first dielectric paste 23A filled in the recessed portions 41 of the molding die 4 are recessed in the first material filling step, the first dielectric paste 23A and the second dielectric paste 22A can be adhered securely to each other. Especially, since the second dielectric paste 22A is in a paste state having a proper fluidity in the transfer step, the second dielectric paste 22A can completely fill the clearances formed on the upper portions of the first dielectric paste 23A while maintaining the desired thickness and shape as the address electrode protective layer 22. With the arrangement, the first dielectric paste 23A can be securely transferred onto the second dielectric paste 22A, so that the address electrode protective layer 22 and the partitions 23 having proper shapes can be securely formed. Accordingly, the PDP 1 having a proper display performance can be manufactured with an enhanced manufacturing efficiency.

The second dielectric paste 22A is applied on the flat rear substrate 2 in the second material application step and the flat surface that is not provided with the recessed portions 41 of the molding die 4 abuts on the portions other than the joint portions 22B of the second dielectric paste 22A to form the portions to be flat in the transfer step. With the arrangement, the inter-partition portions 22D of the address electrode protective layer 22 can be uniformly formed with a uniform thickness. Accordingly, the occurrence of the mis-discharge in the PDP 1 can be prevented.

In addition, since the filling of the first dielectric paste 23A in the recessed portions 41 of the molding die 4 and the application of the second dielectric paste 22A on the rear substrate 2 are performed as different steps, optimum materials can be employed by taking into account the performances required for each of the address electrode protective layer 22 and the partitions 23.

(1-3-2) The viscosity of the second dielectric paste 22A in the transfer step is preferably adjusted to be in the range from 1 to 200 Pa·s, more preferably in the range from 5 to 20 Pa·s.

With the arrangement, the clearances formed on the upper portions of the first dielectric paste 23A can be completely filled while maintaining the desired thickness and shape as the address electrode protective layer 22. Accordingly, the address electrode protective layer 22 and the partitions 23 can be securely formed.

(1-3-3) The first dielectric paste 23A and the second dielectric paste 22A use different materials. Specifically, for instance, a material capable of stably maintaining the shape of the partition 23 is selected for the partition 23, while a material that is less expensive can be selected for the address electrode protective layer 22 having no such limitation. In addition, in view of requirements such as reflectivity and dielectric constant, materials suitable for each of the partition 23 and the address electrode protective layer 22 are selected. Accordingly, the PDP 1 having a higher luminous efficiency and a lower power consumption can be manufactured at low cost.

(1-3-4) In the first material filling step, after applying the first dielectric paste 23A on the surface having the recessed portions 41 of the molding die 4, the rubber flat squeegee is kept in contact with and slid on this surface of the molding die 4. With the operation, the first dielectric paste 23A is fed only in the recessed portions 41 while the first dielectric paste 23A applied on the surface is removed.

Accordingly, only the first dielectric paste 23A filled in the recessed portions 41 can be transferred onto the second dielectric paste 22A, so that the first dielectric paste 23A can be securely transferred even when the upper portions of the first dielectric paste 23A filled in the recessed portions are recessed. Therefore, the partitions 23 having the desired shape can be securely formed without using an excessive amount of the glass paste.

(1-3-5) In the first material filling step, the glass paste containing a photocurable resin is used as the first dielectric paste 23A. In the transfer step, in a state where the molding die 4 and the rear substrate 2 are attached to each other, the light of the specific wavelength is irradiated to the first dielectric paste 23A.

With the arrangement, the first dielectric paste 23A transferred onto the second dielectric paste 22A can be maintained in the shape corresponding to the partitions 23 even when glass particles are not linked to each other before the firing step. Accordingly, the partitions 23 having the desired shape can be securely formed.

(1-3-6) The PDP 1 of the first embodiment includes the rear substrate 2, the front substrate 3, the address electrode protective layer 22 formed so as to cover the surface on the discharge space H side of the rear substrate 2 and the partitions 23 formed on the address electrode protective layer 22 so as to project toward the discharge space H. The address electrode protective layer 22 is so formed that the joint portions 22C with the partitions 23 project toward the partitions 23, while the inter-partition portions 22D that are not provided with the partitions 23 on the surface on the discharge space H side are formed to be flat.

The way the joint portions 22C are formed on the address electrode protective layer 22 is unique to a method of the first embodiment in which the filling of the first dielectric paste 23A in the recessed portions 41 of the molding die 4 and the application of the second dielectric paste 22A on the rear substrate 2 are separately performed as different steps. Then, the address electrode protective layer 22 and the partitions 23 are jointed to each other with the joint portions 22C projecting toward the partitions 23. With the arrangement, even when properties of the components are different, a proper joint condition can be obtained, so that the partitions 23 having the desired shape can be obtained. In addition, the thicknesses of the inter-partition portions 22D of the address electrode protective layer 22 can be uniform, a possibility of occurrence of the mis-discharge can be reduced.

Accordingly, the PDP 1 having a proper display performance can be manufactured with an enhanced manufacturing efficiency.

### (2) Second Embodiment

Now, a second embodiment of the present invention will be described.

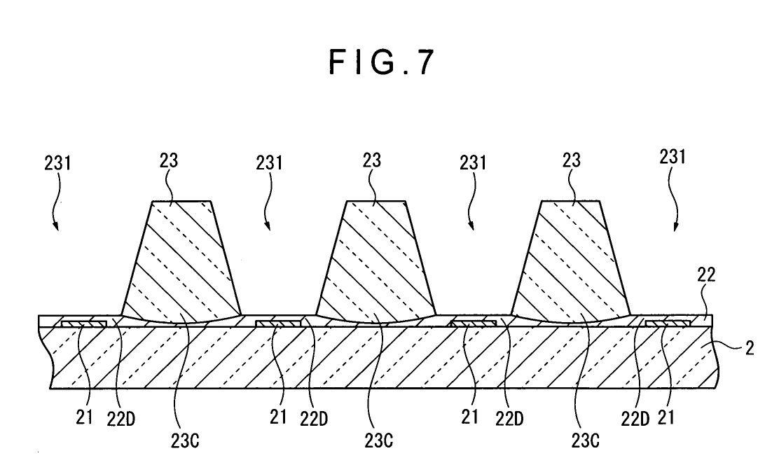

The second embodiment is different from the first embodiment only in that joint portions 23C (see FIG. 7) with the address electrode protective layer 22 of the partitions 23 are formed so as to project toward the address electrode protective layer 22 in the finished rear substrate 2. Accordingly, descriptions of the same arrangements as those in the first embodiment will be omitted.

### (2-1) Manufacturing Method of PDP 1

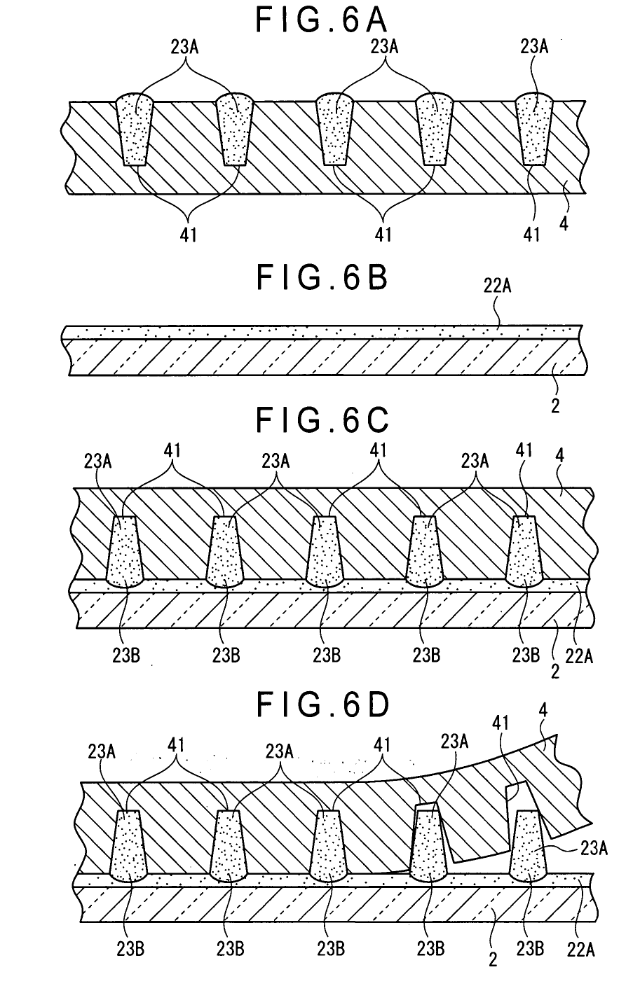

A manufacturing method of the PDP 1 of the second embodiment will be described below with reference to the attached drawings. FIGS. 6A to 6D each schematically show forming steps of the address electrode protective layer and the partition, where FIG. 6A is a cross section of a molding die in a first material filling step; FIG. 6B is a cross section of the rear substrate in a second material application step; FIG. 6C is a cross section showing a state where the molding die is pressed against the rear substrate in a transfer step; and FIG. 6D is a cross section showing a state where the molding die is peeled off from the rear substrate in the transfer step. FIG. 7 is a cross section of the rear substrate after a firing step.

The manufacturing method of the PDP 1 in the second embodiment includes, similarly to the first embodiment, the molding die preparation step, the first material filling step, the second material application step, the transfer step and the firing step to form the address electrode protective layer 22 and the partitions 23.

In the first material filling step, the molding die 4 prepared in the molding die preparation step is used and a silicone resin is sprayed on a surface of a side having the recessed portions 41 of the molding die 4.

Next, the first dielectric paste 23A that forms the partitions 23 is filled in the recessed portions 41 of the molding die 4 using a dispenser or the like (see FIG. 6A). The first dielectric paste 23A used herein is exemplified by a mixture of 15 wt % of a resin that is photo-cured by light of a certain wavelength and 85 wt % of a glass frit containing PbO (glass component).

At this time, a volume of the first dielectric paste 23A to be fed is adjusted so as to be slightly larger than a volume (capacity) of the recessed portions 41, thereby obtaining the first dielectric paste 23A in a state shown in FIG. 6A. Specifically, in this state, the first dielectric paste 23A in the recessed portions 41 project outward from the molding die 4 and this state is maintained by the surface tension. Note that the first dielectric paste 23A in the recessed portions 41 does not flow out to a flat potion between the recessed portions 41 of the molding die 4 due to its surface tension.

In the second material application step, as shown in FIG. 6B, the second dielectric paste 22A that forms the address electrode protective layer 22 is applied to have a predetermined thickness on the rear substrate 2 on which the address electrodes 21 are formed. At this time, similarly to the first embodiment, the viscosity of the second dielectric paste 22A is adjusted such that the viscosity will be in the range from 1 to 200 Pa·s (from 1000 to 200000 cp) in the later-described transfer step. For example, the viscosity of the second dielectric paste 22A is so adjusted that, even when a dry step is provided after applying the second dielectric paste 22A on the rear substrate 2, the second dielectric paste 22A is maintained to be a paste state having the viscosity of 1 to 200 Pa·s (from 1000 to 200000 cp) in the following transfer step.

In the transfer step, the molding die 4 shown in FIG. 6A is opposed to the rear substrate 2 shown in FIG. 6B on which the second dielectric paste 22A is applied, and the molding die 4 and the rear substrate 2 are attached to each other. Then, for instance, a roller having a diameter of 50 mm is moved on a back surface of the molding die 4 to apply a small pressure thereon. With the operation, the first dielectric paste 23A and the second dielectric paste 22A are completely adhered to each other as shown in FIG. 6C. Specifically, since the second dielectric paste 22A is in a paste state and thus fluid, joint portions 23B projecting outward from the molding die 4 of the first dielectric paste 23A are buried in the second dielectric paste 22A. With the arrangement, the first dielectric paste 23A is securely adhered to the second dielectric paste 22A. Note that portions that is not provided with the joint portions 23B of the second dielectric paste 22A are formed to be flat because the flat surface that is not provided with the recessed portions 41 of the molding die 4 abut on the portions.

Thereafter, in a state where the molding die 4 and the rear substrate 2 are attached to each other, light of a certain wavelength is irradiated to the first dielectric paste 23A, and then the molding die 4 is peeled off from the rear substrate 2 as shown in FIG. 6D.

Note that, similarly to the first embodiment, the viscosity of the second dielectric paste 22A in the transfer step is preferably adjusted to be in the range from 1 to 200 Pa·s, more preferably in the range from 5 to 20 Pa·s.

When the viscosity of the second dielectric paste 22A is below the 1 Pa·s, similarly to the first embodiment, the address electrode protective layer 22 cannot be maintained in a desired thickness and shape.

On the other hand, when the viscosity of the second dielectric paste 22A is above 200 Pa·s, it was verified from an experiment that the joint portions 23B of the first dielectric paste 23A cannot be completely buried in the second dielectric paste 22A due to its too high viscosity, so that the joint portions 23B might be crushed or clearances might be generated in the joint portions.

Accordingly, by adjusting the viscosity of the second dielectric paste 22A in the transfer step to be in the range from 1 to 200 Pa·s, the joint portions 23B and portions around the joint portions 23B can be kept in good conditions while maintaining the desired thickness and shape of the address electrode protective layer 22.

Note that in the arrangements disclosed in Documents 4 and 5, the elastic layer and the plastic layer are solidified in attaching the transfer plate and the glass substrate and do not have a proper fluidity unlike the second embodiment, the joint portions 23B of the first dielectric paste 23A might not be buried completely in the second dielectric paste 22A unlike the second embodiment.

In the firing step, the first dielectric paste 23A and the second dielectric paste 22A formed on the rear substrate 2 are fired. With the operation, the address electrode protective layer 22 and the partitions 23 are formed on the rear substrate 2 as shown in FIG. 7.

After forming the address electrode protective layer 22 and the partitions 23 as described above, the fluorescent layers (24R, 24G, 24B) are formed in the discharge cells 231. With the operation, the rear substrate 2 of the PDP 1 is completed.

In the rear substrate 2 obtained by the above-described steps, the partitions 23 are so formed that the joint portions 23C with the address electrode protective layer 22 project toward the address electrode protective layer 22, while the inter-partition portions 22D that are not provided with the partitions 23 of the address electrode protective layer 22 are formed to be flat. In other words, by performing the firing step described above, the joint portions 23B (see FIG. 6C) of the first dielectric paste 23A form the joint portions 23C of the partitions 23, while portions that are not provided with the joint portions 23B of the second dielectric paste 22A form the inter-partition portions 22D of the address electrode protective layer 22.

According to the second embodiment described above, the thicknesses of the inter-partition portions 22D can be maintained uniformly and occurrence of the mis-discharge in the PDP 1 can be prevented similarly to the first embodiment.

### (2-2) Advantages of Second Embodiment

According to the second embodiment, in addition to advantages substantially the same as those described in (1-3-1), (1-3-3) and (1-3-5) of the first embodiment, the following advantages can be attained.

(2-2-1) The PDP 1 of the second embodiment includes the rear substrate 2, the front substrate 3, the address electrode protective layer 22 formed so as to cover the surface on the discharge space H side of the rear substrate 2 and the partitions 23 formed on the address electrode protective layer 22 so as to project toward the discharge space H. The partitions 23 are so formed that the joint portions 23C with the address electrode protective layer 22 project toward the address electrode protective layer 22, while the inter-partition portions 22D that are not provided with the partitions 23 on the surface on the discharge space H side of the address electrode protective layer 22 are formed to be flat.

The way the joint portions 23C are formed on the partitions 23 is unique to a method of the second embodiment in which the filling of the first dielectric paste 23A in the recessed portions 41 of the molding die 4 and the application of the second dielectric paste 22A on the rear substrate 2 are separately performed as different steps. Then, the address electrode protective layer 22 and the partitions 23 are jointed to each other with the joint portions 23C projecting toward the address electrode protective layer 22. With the arrangement, even when properties of the components are different, a proper joint condition can be obtained, so that the partitions 23 having the desired shape can be obtained. In addition, the thicknesses of the inter-partition portions 22D of the address electrode protective layer 22 can be uniform, a possibility of occurrence of the mis-discharge can be reduced.

Accordingly, the PDP 1 having a proper display performance can be manufactured with an enhanced manufacturing efficiency.

(2-2-2) In the first material filling step, the volume of the first dielectric paste 23A to be fed is adjusted to be slightly larger than the volume of the recessed portions 41 so that the upper portions of the first dielectric paste 23A project outward from the molding die 4. The viscosity of the second dielectric paste 22A in the transfer step is preferably adjusted to be in the range from 1 to 200 Pa·s, more preferably in the range from 5 to 20 Pa·s.

With the arrangement, the joint portions 23B and the portions around the joint portions 23B can be formed in good conditions while maintaining the desired thickness and shape as the address electrode protective layer 22. Accordingly, the address electrode protective layer 22 and the partitions 23 can be securely formed.

### (3) Third Embodiment

In addition to the embodiments above, the manufacturing method of the plasma display panel of the present invention is also applicable to form an address electrode protective layer and partitions on a front substrate of a so-called transmissive type PDP. In such case, the address electrode protective layer and the partitions can be formed similarly to the address electrode protective layer 22 and the partitions 23 of the first and second embodiments above.

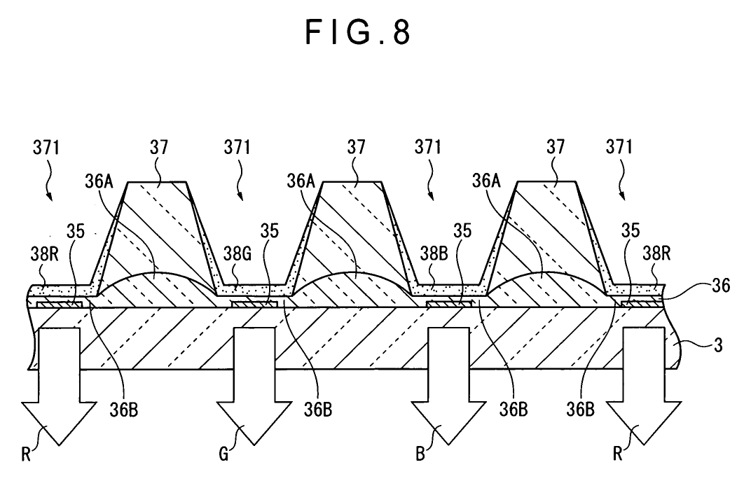

This application example will be described below as a third embodiment. FIG. 8 is a cross section of the front substrate after a firing step according to the third embodiment. Note that FIG. 8 shows as an example an arrangement in which joint portions 36A of the address electrode protective layer 36 are provided so as to project toward partitions 37 similarly to the first embodiment, and description and drawings of an arrangement in which the address electrode protective layer 36 and the partitions 37 are formed similarly to the second embodiment will be appropriately omitted.

### (3-1) Arrangement of Transmissive Type PDP

The transmissive type PDP of the third embodiment is substantially the same as an arrangement in which the rear substrate 2 of the PDP 1 in the first and second embodiments is provided as a display surface side. In the transmissive type PDP, discharge emission generated in each discharge cell excites luminous layers provided to a front substrate 3 and visible light is transmitted from the front substrate 3 as shown in the arrows R, G, B in FIG. 8.

Specifically, in the transmissive type PDP of the third embodiment, the front substrate 3 is provided with a plurality of linear address electrodes 35, a transmissive address electrode protective layer 36 covering the address electrodes 35, partitions 37 integrally formed on the address electrode protective layer 36 and fluorescent layers (38R, 38G, 38B) that are formed in discharge cells 371 defined by the partitions 37. Although not shown, the rear substrate includes a plurality of display electrode pairs arranged at a predetermined interval in a direction substantially orthogonal to the address electrodes 35, a dielectric layer that covers the display electrode pairs and a protective layer that covers the dielectric layer. Note that since these components are substantially the same as the components of the PDP 1 in the first and second embodiments, descriptions thereof will be omitted.

### (3-2) Manufacturing Method of Transmissive Type PDP

In a manufacturing method of the transmissive type PDP, as a preceding process for forming the address electrode protective layer 36 and the partitions 37, a pattern of the address electrodes 35 are formed in advance on an inner surface side of the front substrate 3.

Thereafter, the forming steps of the address electrode protective layer 36 and the partitions 37 are performed. Specifically, the molding die preparation step, the first material filling step, the second material application step, the transfer step and the firing step are performed. Note that since these steps are substantially the same as the steps in the first and second embodiments, descriptions thereof will be omitted.

Note that, similarly to the first and second embodiments, the viscosity of the second dielectric paste 22A that forms the address electrode protective layer 36 is preferably adjusted to be in the range from 1 to 200 Pa·s in the transfer step, more preferably in the range from 5 to 20 Pa·s. With the arrangement, the address electrode protective layer 36 and the partitions 37 having desired shapes can be securely formed similarly to the first and second embodiments.

After the forming steps of the address electrode protective layer 36 and the partitions 37, fluorescent pastes of three primary colors of red (R), green (G) and blue (B) are applied in the discharge cells 371 by screen printing or the like, which are fired to form the fluorescent layers (38R, 38G, 38B). With the operation, the front substrate 3 of the transmissive type PDP is completed.

In the front substrate 3 obtained by the above-described steps, when the address electrode protective layer 36 and the partitions 37 are formed in a manner similar to the first embodiment, the address electrode protective layer 36 is so formed that the joint portions 36A with the partitions 37 project toward the partitions 37, while inter-partition portions 36B that are not provided with the partitions 37 are formed to be flat as shown in FIG. 8.

On the other hand, although not shown, when the address electrode protective layer 36 and the partitions 37 are formed in a manner similar to the second embodiment, the partitions 37 are so formed that joint portions with the address electrode protective layer 36 projects toward the address electrode protective layer 36, while inter-partition portions that are not provided with the partitions 37 in the address electrode protective layer 36 are formed to be flat.

As described above, in both of the cases above, the inter-partition portions 36B each defining a part of the discharge cell 231 are formed to have a uniform thickness, the mis-discharge of the PDP can be prevented as in the first and second embodiments.

Further, in the third embodiment, since the filling of the first dielectric paste (corresponding to the partitions 37) in the recessed portions of the molding die and the application of the second dielectric paste (corresponding to the address electrode protective layer 36) on the front substrate 3 are performed as different steps, different materials can be employed for the first dielectric paste and the second dielectric paste.

Accordingly, optimum materials can be selected by taking into account performances required for each of the address electrode protective layer 36 and the partition 37. Specifically, for instance, the partition 37 preferably has a high reflectivity in terms of enhancing light extraction efficiency, while the address electrode protective layer 36 requires to be light-transmissive because the address electrode protective layer 36 needs to emit light emitted by the fluorescent layers (38R, 38G, 38B) of the front substrate 3 to the outside of the display surface. As described above, requirements of materials are different in the partition 37 and the address electrode protective layer 36. In the third embodiment, since the first dielectric paste and the second dielectric paste can be formed from different materials and use materials optimum for the requirements, a PDP having a high emission efficiency and a low power consumption can be manufactured.

### (3-3) Advantage of Third Embodiment

According to the third embodiment above, advantages substantially similar to the advantages described in (1-3) of the first embodiment or in (2-2) of the second embodiment can be attained.

### Modifications of Embodiment

It should be noted that the present invention is not limited to the embodiments above but includes the following modifications as long as the object of the present invention can be achieved.

For example, in the first to third embodiments, the first dielectric paste that forms the partitions 23, 37 contains the photocurable resin, but the arrangement is not limited thereto. Specifically, the first dielectric paste may not contain the photocurable resin as long as the first dielectric paste has a viscosity capable of maintaining the desired shape in a state where the first dielectric paste is transferred onto the second dielectric paste. With the arrangement, the light having a certain wavelength does not have to be irradiated to the first dielectric paste 23A in the transfer step, thereby simplifying the manufacturing steps and lowering a manufacturing cost.

Although, the first dielectric paste that forms the partitions 23, 37 and the second dielectric paste that forms the address electrode protective layer 22, 36 use different materials in the first to third embodiments, the first dielectric paste and the second dielectric paste may use a common material. In such case, since raw materials and the like of the first dielectric paste and the second dielectric paste can be uniformed, preparation for each paste can be simplified.

### Advantages of Embodiment

As described above, the manufacturing method of the PDP 1 of the embodiments above includes the first material filling step, the second material application step, the transfer step and the firing step. In the first material filling step, the first dielectric paste 23A that forms the partitions 23 are filled in the recessed portions 41 of the molding die 4. In the second material application step, the second dielectric paste 22A that forms the address electrode protective layer 22 is applied onto the rear substrate 2. In the transfer step, the molding die 4 is pressed against the second dielectric paste 22A and then the molding die 4 is peeled off from the rear substrate 2, whereby the first dielectric paste 23A is transferred onto the second dielectric paste 22A. In the firing step, the second dielectric paste 22A and the first dielectric paste 23A are fired to form the address electrode protective layer 22 and the partitions 23 on the rear substrate 2.

As described above, since the molding die 4 is pressed against the second dielectric paste 22A having a fluidity, the first dielectric paste 23A and the second dielectric paste 22A can be adhered to each other securely. With the arrangement, the first dielectric paste 23A can be securely transferred onto the second dielectric paste 22A, so that the partitions 23 having the desired shape can be securely formed. Accordingly, the PDP 1 having a proper display performance can be manufactured with an enhanced manufacturing efficiency.

In the second material application step, the second dielectric paste 22A is applied on the flat rear substrate 2, the inter-partition portions 22D of the address electrode protective layer 22 can be uniformly formed with a uniform thickness. Accordingly, the occurrence of the mis-discharge in PDP 1 can be prevented.

In addition, since the filling of the first dielectric paste 23A in the recessed portions 41 of the molding die 4 and the application of the second dielectric paste 22A on the rear substrate 2 are performed as different steps, optimum materials can be employed by taking into account the performances required for each of the address electrode protective layer 22 and the partitions 23.

The PDP 1 of the embodiments above includes the rear substrate 2, the front substrate 3, the address electrode protective layer 22 formed so as to cover the surface on the discharge space H side of the rear substrate 2 and the partitions 23 formed on the address electrode protective layer 22 so as to project toward the discharge space H. The address electrode protective layer 22 is so formed that the joint portions 22C with the partitions 23 project toward the partitions 23, while the inter-partition portions 22D that are not provided with the partitions 23 on the surface on the discharge space H side are formed to be flat.

The way the joint portions 22C are formed on the address electrode protective layer 22 is unique to a manufacturing method of the PDP in which the filling of the first dielectric paste 23A in the recessed portions 41 of the molding die 4 and the application of the second dielectric paste 22A on the rear substrate 2 are separately performed as different steps. Then, the address electrode protective layer 22 and the partitions 23 are jointed to each other with the joint portions 22C projecting toward the partitions 23. With the arrangement, even when properties of the components are different, a proper joint condition can be obtained, so that the partitions 23 having the desired shape can be obtained. In addition, the thicknesses of the inter-partition portions 22D of the address electrode protective layer 22 can be uniform, a possibility of occurrence of the mis-discharge can be reduced. Accordingly, the PDP 1 having a proper display performance can be manufactured with an enhanced manufacturing efficiency.

The PDP 1 of the embodiments above includes the rear substrate 2, the front substrate 3, the address electrode protective layer 22 formed so as to cover the surface on the discharge space H side of the rear substrate 2 and the partitions 23 formed on the address electrode protective layer 22 so as to project toward the discharge space H. The partitions 23 are so formed that the joint portions 23C with the address electrode protective layer 22 project toward the address electrode protective layer 22, while the inter-partition portions 22D that are not provided with the partitions 23 on the surface on the discharge space H side of the address electrode protective layer 22 are formed to be flat.

The way the joint portions 23C are formed on the partitions 23 is unique to a manufacturing method of the PDP in which the filling of the first dielectric paste 23A in the recessed portions 41 of the molding die 4 and the application of the second dielectric paste 22A on the rear substrate 2 are separately performed as different steps. Then, the address electrode protective layer 22 and the partitions 23 are jointed to each other with the joint portions 23C projecting toward the address electrode protective layer 22. With the arrangement, even when properties of the components are different, a proper joint condition can be obtained, so that the partitions 23 having the desired shape can be obtained. In addition, the thicknesses of the inter-partition portions 22D of the address electrode protective layer 22 can be uniform, a possibility of occurrence of the mis-discharge can be reduced. Accordingly, the PDP 1 having a proper display performance can be manufactured with an enhanced manufacturing efficiency.

The priority application Number JP2006-106872 upon which this patent application is based are hereby incorporated by reference.

What is claimed is:

1. A manufacturing method of a plasma display that includes a pair of substrates facing each other with a discharge space therebetween, a dielectric layer that is provided so as to cover a surface of one substrate of the pair of substrates, the surface being on a discharge space side, partitions provided on the dielectric layer, the partitions projecting toward the discharge space so as to zone the discharge space into a plurality of unit emitting regions, the method comprising:
a first material filling step for filling recessed portions of a molding die with a first material that forms the partitions, the recessed portions each having a shape inverted to a desired shape of the partitions;
a second material application step for applying a second material in a paste form that forms the dielectric layer on the surface on the discharge space side of the one substrate, the second material applied to have a predetermined thickness;
a transfer step for pressing the molding die with its recessed portions filled with the first material against the second material in the paste form applied on the one substrate and peeling the molding die from the one substrate to transfer the first material onto the second material; and
a firing step for firing the second material applied on the one substrate and the first material transferred onto the second material to form the dielectric layer and the partitions on the one substrate.

2. The manufacturing method according to claim 1, wherein a viscosity of the second material during the transfer step is set in the range from 1 Pa·s to 200 Pa·s.

3. The manufacturing method according to claim 1, wherein the first material and the second material are different materials.

4. The manufacturing method according to claim 1, wherein in the first material filling step, after the first material is applied on a surface having the recessed portions of the molding die, the first material is removed from the surface so that the first material is fed only in the recessed portions.

5. The manufacturing method according to claim 1, wherein
the one substrate is a rear substrate that is provided on an opposite side of a display surface,
the dielectric layer covers the surface on the discharge space side of the rear substrate and an electrode provided on the surface, and
the partitions are provided on the dielectric layer, the partitions projecting toward the discharge space so as to zone the discharge space in the plurality of unit emitting regions.

6. The manufacturing method according to claim 1, wherein
the one substrate is a front substrate that is provided on a side of a display surface,
the dielectric layer is light-transmissive, the dielectric layer covering the surface on the discharge space side of the front substrate and an electrode provided on the surface, and
the partitions are provided on the dielectric layer, the partitions projecting toward the discharge space so as to zone the discharge space into a plurality of unit emitting regions, a fluorescent layer formed so as to cover the a bottom surface and lateral surfaces of each of the unit emitting regions.

7. A plasma display that includes a pair of substrates facing each other with a discharge space therebetween, a dielectric layer that is provided so as to cover a surface of one substrate of the pair of substrates, the surface being on a discharge space side, partitions provided on the dielectric layer, the partitions projecting toward the discharge space so as to zone the discharge space into a plurality of unit emitting regions, wherein:
the dielectric layer is so provided that joint portions jointing with the partitions project toward the partitions while portions that are not provided with the partitions in the surface on the discharge space side are formed to be flat.

8. A plasma display that includes a pair of substrates facing each other with a discharge space therebetween, a dielectric layer that is provided so as to cover a surface of one substrate of the pair of substrates, the surface being on a discharge space side, partitions provided on the dielectric layer, the partitions projecting toward the discharge space so as to zone the discharge space into a plurality of unit emitting regions, wherein:
the partitions are so provided that joint portions jointing with the dielectric layer project toward the dielectric layer, and
portions that are not provided with the partitions in the surface on the discharge space side of the dielectric layer are formed to be flat.
